(19) United States
(12) Patent Application Publication
(10) Pub. No.: US 2023/0332659 A1
(43) Pub. Date: Oct. 19, 2023

(54) ELASTOMERIC ISOLATOR

(71) Applicant: UNIVERSITY OF EXETER, Devon (GB)

(72) Inventors: Maria Rosaria MARSICO, Exeter (GB); Julián Mauricio Londono MONSALVE, Exeter (GB); Monica F. CRACIUN, Exeter (GB)

(73) Assignee: UNIVERSITY OF EXETER, Devon (GB)

(21) Appl. No.: 17/909,664

(22) PCT Filed: Feb. 26, 2021
(86) PCT No.: PCT/EP2021/054904

§ 371 Date: Sep. 6, 2022

(30) Foreign Application Priority Data
Mar. 6, 2020 (GB) 2003251.2

(51) Int. Cl. F16F 1/36; C08J 7/06; E04H 9/02; B32B 9/00; B32B 9/04; B32B 15/06; B32B 15/18; B32B 25/12; B32B 25/14

(52) U.S. Cl. CPC F16F 1/3605; C08J 7/06; E04H 9/022; B32B 9/007; B32B 9/043; B32B 15/06; B32B 15/18; B32B 25/12; B32B 25/14; C08J 2307/00; F16F 2224/025; F16F 2224/02; F16F 1/40

(57) ABSTRACT

An elastomeric isolator is described comprising a layer of an elastomeric material, wherein the layer of elastomeric material is provided with a reinforcing material layer in the form of a graphene layer.

This invention relates to novel Graphene-Reinforced Elastomeric Isolators (GREI).

Elastomeric Isolators are special devices used for seismic isolation of structures. They are made of alternate layers of steel and rubber (SREI) and they positioned between the structure and its foundations to decouple them. SREI's heavy weight and complex manufacturing process drive costs up, this restricts their use to strategic buildings such as hospitals and civic centres. In recent years, alternative materials have been proposed to replace the steel sheets of SREI, e.g., glass or carbon fibres-reinforced elastomeric isolators (FREI); however, their mechanical behaviour required further investigation before being implemented in existing and new structures safely. As a promising alternative, GREI is proposed here to overcome the heavy weight and long manufacturing process of SREI and the mechanical limitation of FREI to seismic excitations.

This manuscript presents an experimental dynamic analysis on rubber pads reinforced with layers of graphene. Results show that a few layer graphene transferred on a rubber pad increase stiffness and damping of the graphene-based composite; also results show that the mechanical properties of the graphene-rubber composite alter when varying the thickness of a few layer graphene transferred on rubber pads.

### 1. INTRODUCTION

Elastomeric Isolators (EIs) are devices used to isolate structures from seismic or ground borne excitations in general. They are stiff vertically yet flexible horizontally, and are interposed between the structure and its foundations to decouple them. The concept of interposing those devices is known as base isolation; it is accepted by all major international seismic codes and enables structures to survive potentially devastating seismic events. However, at present the use of base isolation technology is restricted primarily to strategic buildings such as hospitals and civic centres due to the high costs associated with their manufacturing, shipping, handling and installation. In order to extend the use of this technology to residential and commercial buildings, on a global scale, there is in an on-going quest for new materials for elastomeric isolators which will result in highly efficient, ultra-lightweight and low-cost devices. Current technologies for base isolation use steel-reinforced elastomeric isolators (SREI) to mitigate earthquake induced vibrations, and to protect structures as well as their contents.^{[1-2]} SREIs are made of alternate layers of steel and rubber and are used mainly in strategic and public buildings due to high cost of designing, production and installation e.g. San Francisco City Hall, and Government Office of Toshima Ward in Tokyo. With the exception of Japan which has about 4,100 base-isolated commercial and institutional buildings, only a few seismic-prone countries are firmly committed to base isolation methodology (e.g. Turkey, China).^{[3]}

The primary weight in a SREI is due to the reinforcing steel shims which are used to provide the rubber-steel composite with high vertical stiffness, and to the end steel plates at the bottom and top which are used to secure the device to the structure and the foundations. Reducing the weight of EIs would facilitate the manufacturing, shipping, handling and installation and would extend the use of this technology to residential and commercial buildings in many parts of the world. Fibre-reinforced elastomeric isolators (FREIs) are proposed as a less expensive alternative to SREI, to reduce weight, cost, and manufacturing process time.^{[2,4-5]} FREIs are made of layers of rubber reinforced with fibre sheets (e.g. glass or carbon fibres) which are lighter than steel shims.

A number of studies have been conducted to investigate the dynamic behaviour of FREIs during earthquakes.^{[2-4,6-9]} Kelly and Takhirov have carried out a theoretical and experimental analysis on FREI and have defined design criteria which were used to manufacture and to test prototypes. To reduce weight further FREIs can be installed without thick steel plates at the top and the bottom, so they relies essentially on friction from the isolator to the superstructure and foundations.^{[5]}

Unbounded FREIs specimens reinforced by twisted stands of Kevlar were constructed and tested at the Pacific Earthquake Engineering Research Centre, Berkeley.^{[4]} In unfixed FREIs the total thickness of the rubber (tᵣ) is almost equal to the height of the bearing (h), as the total thickness of the fibre sheets is negligible compared to the thickness of the elastomer. Experimental results show that the vertical stiffness of FREI, which makes the isolator stable against large vertical loads, is ^{˜}20% less than the equivalent for SREI.^{[4]} These results do not compromise the stability of FREIs as they are stable up to a peak shear strain of 150%, but they raise concerns whether it is possible to produce FREIs with the same (or higher) load capability and flexibility as SREIs to undergo large horizontal displacements during a seismic event. It was also observed experimentally that fibre reinforcement adds significant frictional damping due to individual strands in the fibre bundle slipping against each other when a FREI is displaced in shear. This means that in an isolation system even lower modulus elastomers can be used, which reduces costs further.

Experimental studies have investigated crucial parameters of FREIs such as vertical stress, horizontal deflection, bearing height, number of layers of elastomer and reinforcement, reinforcement material and damping coefficient. Strauss et al. found that the stiffness of FREIs depends on the pre-loading situation; the fibres have the ability to align according to the loading direction and, hence, the material behaviour is characterized as a degradation dependent. This may be an uncertain parameter when the preloading situation of the fibres is unknown.^{[2]}

Numerous studies suggest the use of FREI in lieu of heavy SREI, albeit aspects such as design, alignment and behaviour of the fibres would require further investigation. In particular, the dependence of FREI to preloading history, fibre alignment and pretension remain unclear, bringing uncertainty into the design, manufacturing and performance of those devices.^{[10]}

An attractive alternative to using fibres to reinforce rubber is graphene. Graphene, a one-atom thick layer of carbon, is one of the thinnest materials which can be conceived. It is the strongest known material, which is also mechanically flexible. The superior mechanical properties of graphene have already made this material a top candidate for various emerging applications from flexible electronics to providing unprecedented outstanding reinforcement in composites.^{[11-13]} Many studies were conducted to determine the mechanical properties, electrical conductivity, gas permeability and thermal stability of this material; however, there are only a few works that incorporate graphene into elastomers. For instance, Prud'Homme et al. added thermally-reduced graphene into several elastomers, and their work demonstrates the prominent potential of graphene in improving the mechanical properties of elastomers.^{[14]} Wu et al. studied the influence of graphene on the vulcanization kinetics of natural rubber with sulfur curing system, and observed that graphene can be used to tune the vulcanization kinetics of rubbers.^{[15]}

The idea behind the research presented in this paper is to reinforce pure rubber with a few-layer graphene and to create Graphene-Reinforced Elastomeric Isolator (GREI), that have to be stiffer vertically than horizontally to accommodate earthquake-induced vibrations to structures. This research also aims at exploiting the properties of graphene to enhance the damping of the graphene-rubber compound. Additional damping in the graphene-rubber compound will open the possibility of using pure rubber in lieu of high damping rubber reinforced with special particles; this will lead to further costs saving of those devices. The dynamic response of square and circular graphene-rubber specimens with applied vertical load is investigated. In Section 2 the composition of the specimens and the experimental setup are described. In Section 3 the theoretical background is presented. In Section 4 experimental results are analysed and discussed.

It is an object of the invention to provide an improved elastomeric isolator.

According to the present invention there is provided an elastomeric isolator comprising a layer of an elastomeric material, wherein the layer of elastomeric material is provided with a reinforcing material layer in the form of a graphene layer.

The graphene layer may be applied to a face of the elastomeric material. The graphene layer may comprise at least one few layer graphene nanosheet.

The elastomeric material may be located between a pair of steel plates.

The invention will further be described, by way of example, with reference to the accompanying drawings.

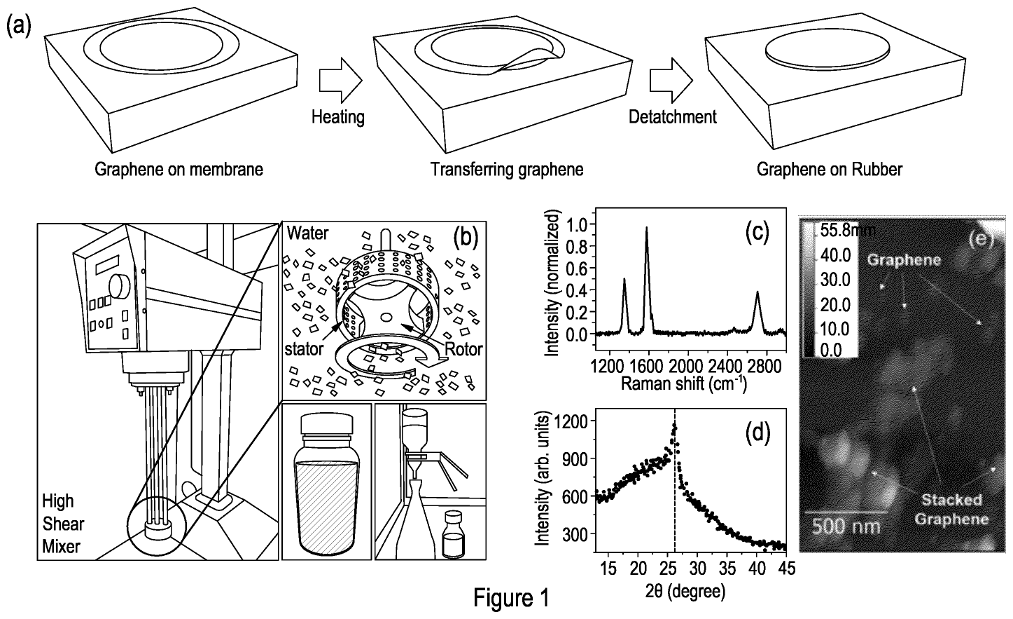

FIG. 1. Preparation of water exfoliated graphene solution, transfer of graphene on the rubber, and its characterization. (a) The scheme of transfer of graphene from the filter membrane to the rubber. (b) The photo images of high shear mixer, graphene solution obtained, and vacuum filtration that allows to initially deposit graphene film on the filter membrane. The scheme of exfoliated graphene nanosheets with NaC in water due to a shear force caused by the holes of the stator and rotating the rotor. (c) Raman and (d) XRD spectra of graphene film. (e) AFM images of graphene film.

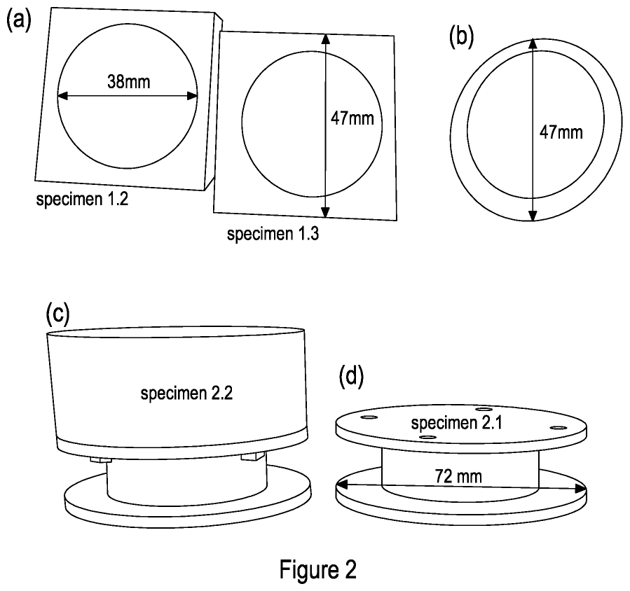

FIG. 2. (a) Specimens 1.2 and 1.3 made of a square rubber pad 15 mm thick, with thick (left) and thin (right) layer of graphene transferred on top. (b) Circular sample: 1.5 mm thick rubber pad with a few layer graphene on top. (c) Specimen 2.2: nine circular rubber pads with diameter 47 mm and thickness 1.5 mm reinforced with 8 layers of graphene and 1 kg vertical load. (d) Specimen 2.1: nine circular rubber pads.

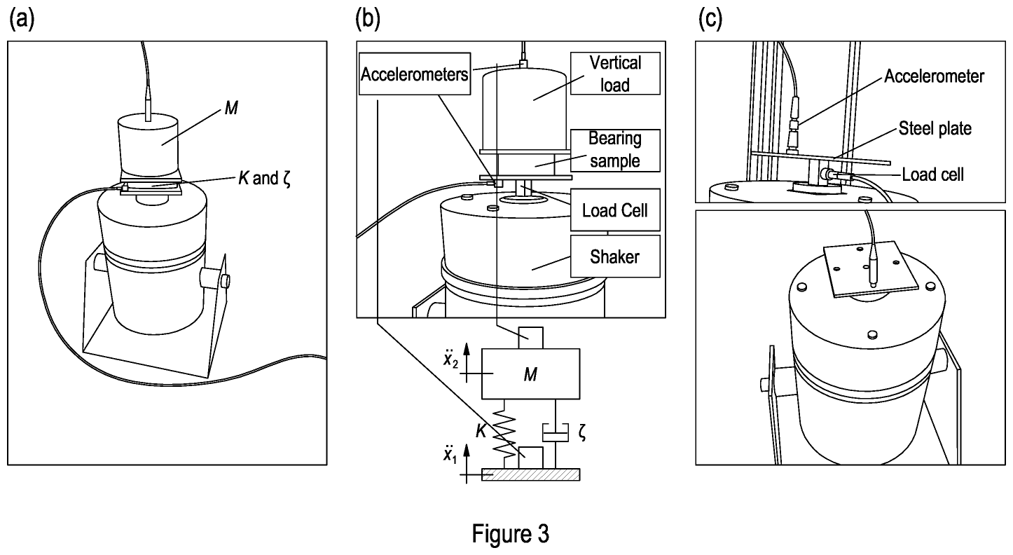

FIG. 3. (a) Experimental setup; (b) corresponding SDOF mass-spring-damper system. Components of the experimental setup. (c) Experimental tests conducted on a square steel plate 3 mm thick.

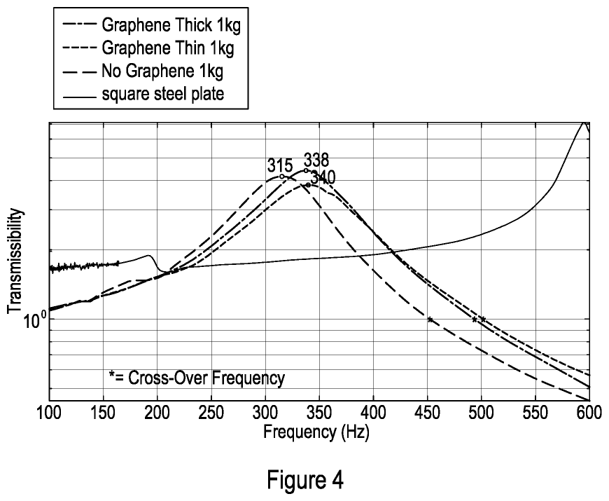

FIG. 4. Set 1 samples: transmissibility and cross-over frequency at T=1.

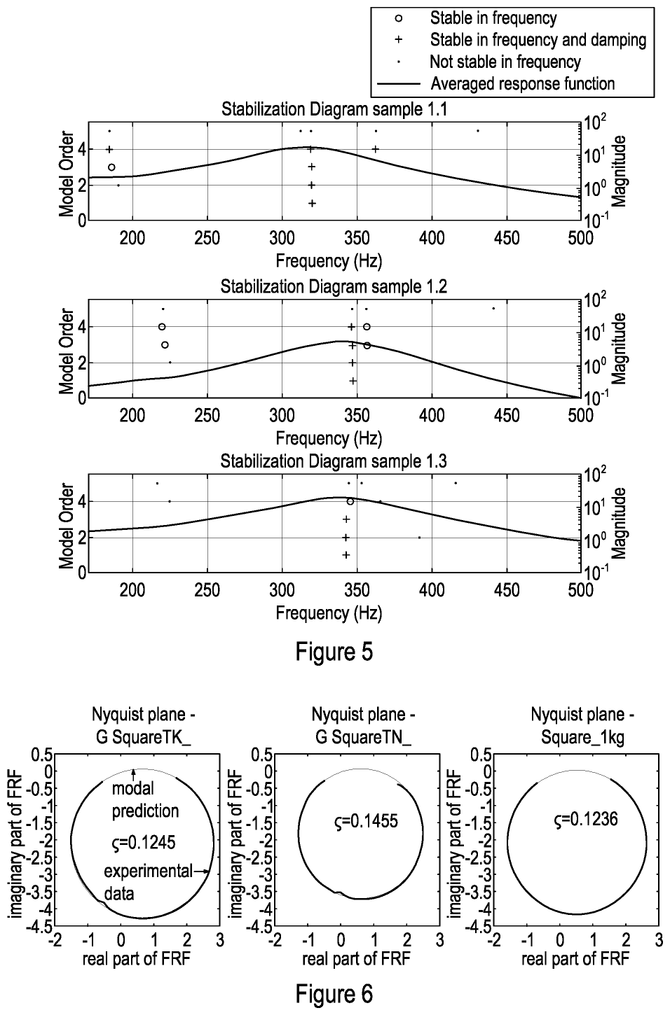

FIG. 5. Stabilization diagram Set 1 samples.

FIG. 6. Nyquist plane for the three Set 1 samples with 1 kg vertical load.

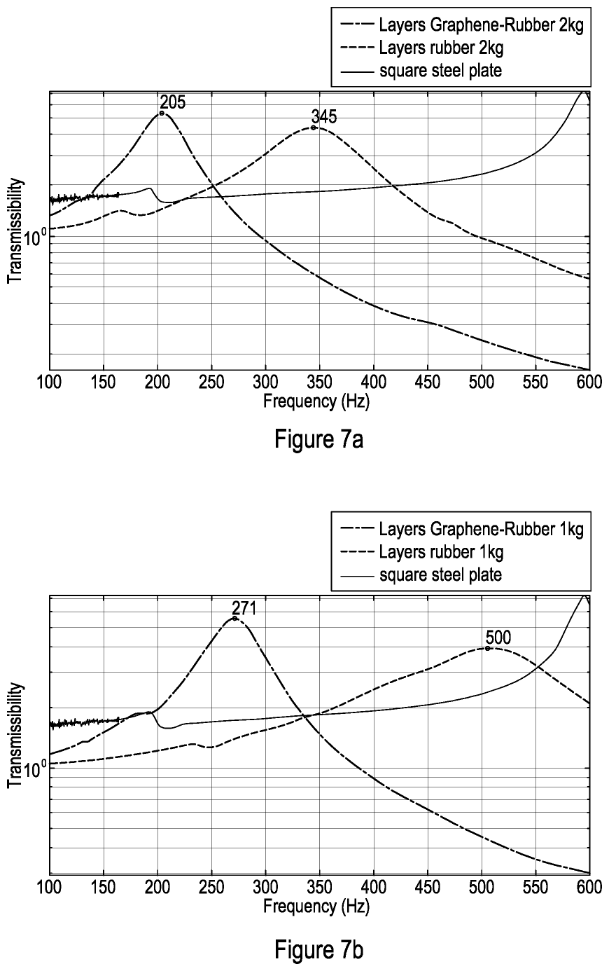

FIG. 7. Transmissibility of Set 2 samples; (a) specimens with vertical load 1 kg; (b) specimens with vertical load 2 kg.

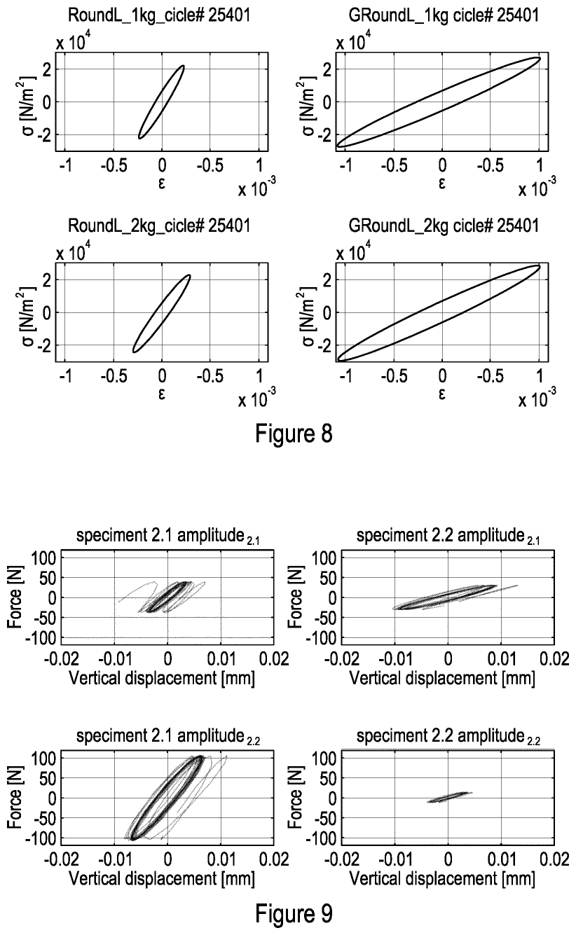

FIG. 8. Young's Modulus Eex for Set 2 samples. (a) Specimen 2.1 under 1 kg; (b) specimen 2.2 under 1 kg; (c) specimen 2.1 under 2 kg; (d) specimen 2.2 under 2 kg.

FIG. 9. Relative vertical displacement versus effectively applied force of specimen 2.1 and 2.2 with 1 kg vertical load applied.

### 2. COMPOSITION OF SPECIMENS AND EXPERIMENTAL SETUP

### 2.1. Description of the Specimens

Graphene deposition on rubber was achieved by a transfer method we have developed recently, isopropyl alcohol (IPA) assisted direct transfer method (IDT).^{[16]} Specifically, a graphene film consisting of a random network of nanosheets was first deposited on a filter membrane (Milipore, hydrophilic polyteterafluoroethylene (PTFE) with 200 nm pores and 47 mm diameter) and then transferred onto rubber by IDT at 50° C. due to IPA evaporation (see previous our work for the details of transfer mechanism^{[16]}), as shown in FIG. 1a. Few layer graphene nanosheets, composing the graphene film on rubber, was prepared in water by shear exfoliation technique (FIG. 1b).^{[16,17]} In this technique a mechanical force produced by rotating the rotor inside the high shear mixer head allows for the liquid phase exfoliation of graphite flakes (Sigma-Aldrich, 332461) into ultrathin few layer graphene nanosheets (the scheme in FIG. 1b). Sodium cholate, which is an amphiphilic surfactant, was used to settle the exfoliated few layer graphene nanosheets in water (red dots covered graphene sheet in the scheme of FIG. 1b). The water exfoliated graphene solution was obtained after shear exfoliation at 4500 rpm for 60 min and a centrifugation process at 1500 rpm for 100 min to remove the unexfoliated graphite.^{[16]} Graphene films were initially obtained on a membrane by vacuum filtration of 15 ml of graphene solution (image panel in right-down side of FIG. 1b) and then transferred onto rubber. To vary the thickness of the graphene films on rubber, multiple transfers of graphene films were used (i.e. 3 transfers for the thin films and 6 transfers for the thick films). The crystallinity of graphene nanosheets was characterized by Raman spectroscopy (using a custom-built setup^{[18]} based on an Olympus coupled to Princeton Instruments ACTON-SP2500 spectrometer (1800 g/mm, 500 nm Blaze) with a PIXIS-400 eXcelon CCD) and X-Ray Diffraction (XRD, the Bruker D8 advanced XRD), as shown in FIGS. 1c and d. The Raman spectra in FIG. 1c shows the characteristic peaks of sp2 bonded carbon atoms: the D-peak at 1340 cm⁻¹, the G-peak around 1600 cm⁻¹, the D′-peak around 1620 cm⁻¹, and the 2D-peak at 2700 cm⁻¹. The position of defects that could be induced in graphene by shear exfoliation can be estimated by the intensities ratio of D- and D′-band in the Raman spectra located at.^{[16,17]} We obtained I(D)/I(D′)≈4.7, which means that graphene has most edge defects and few defects on the basal plane of graphene, but we note that the contribution of detects on the basal plane is not introduced by shear exfoliation process because graphene flakes already have basal plane defects (I(D)/I(G)≈0.0555). Additionally, we observed a high crystalline quality of graphene film by XRD, obtaining 26.6° peak same as a main peak position of graphite, which is in agreement with previous Raman and XPS data. FIG. 1e shows the Atomic Force Microscopy (AFM, the Bruker Innova AFM system in Tapping mode) image of stacked few layer graphene nanosheets prepared on SiO₂/Si substrate. The average of number of layers and nanosheet lateral size of graphene is 4 layers and ^{˜}110 nm, respectively and has been reported in elsewhere.^{[16]} We observed aggregated few layer graphene nanosheets to form film with the random networks. FIG. 2 shows two square rubber pads with thick and thin layers of graphene on top.

In order to study the influence of the shape factor, which is a dimensionless measure of the aspect ratio of the single layer of the elastomer and it is defined as the ratio between loaded area and force-free area, we have manufactured two sets of samples, with circular and square geometries. Set 1 samples are confined to two 72×72 mm square steel plates 3 mm thick, while Set 2 samples are confined to two circular steel plates 3 mm thick with 72 mm diameter.

Set 1 consists of three specimens. Specimen 1.1 is made of a square pure rubber pad 47 mm side and 15 mm thick; Specimen 1.2 is made of a square rubber pad 47 mm side and 15 mm thick with a circular thick layer of graphene on the top with diameter of 38 mm; and Specimen 1.3 is made of a square rubber pad 47 mm and 15 mm thick side with a circular thin layer of graphene on the top with diameter of 38 mm.

Set 2 consists of two specimens made with nine circular pads of rubber each with diameter 47 mm and thickness 1.5 mm. Specimen 2.1 is made of nine pads of pure rubber bonded together using a cold vulcanizing agent. Specimen 2.2 is made of nine pads of rubber alternated to eight circular thin layers of graphene with diameter 38 mm. Thin layers of graphene were transferred upon the rubber pads using ^{˜}45 ml of graphene solution in water solvent. Rubber pads with graphene on top were bound one another using a cold vulcanizing agent. FIG. 2 shows circular specimens 2.1 and 2.2 (a-b), an enlargement of specimen 2.2 (c) and a 1.5 mm rubber pad with graphene transferred on top (d) that is repeated nine times to make specimen 2.2.

The total height of the specimens (h) is assumed equal to the thickness of the rubber that is 15 mm for Set 1 and 13.5 mm for Set 2 samples. Indeed, the thickness of a few-layer graphene t_{g} transferred on top of the rubber pad is negligible (a ten-layer graphene film is ^{˜}4.61 nm). The elastomer used in Set 1 and Set 2 samples is natural rubber with hardness 70° Shore A Degree, measured experimentally using a RS Pro digital durometer with application range of 10-90 Shore A unit and ±1 hardness unit accuracy. Set 1 and Set 2 samples were cured for 15 days at room temperature of approximately 20° before being tested.

### 2.2. Experimental Setup

The experimental setup shown in FIG. 3a can be seen as a single-degree-of-freedom (SDOF) mass-spring-damper system (FIG. 3b). M is the load applied on a specimen, K and ζ are the stiffness and the damping of the specimen; \ddot{x}₁ is the acceleration recorded at the bottom of the lower steel plate bonded to the specimen and \ddot{x}₂ is the acceleration recorded at the top of the added mass. Initial tests were conducted on three Set 1 square samples, and the second sequence of tests was conducted on two Set 2 circular samples described in Section 2. Experimental modal analysis was performed on the mass-spring-damper system and the dynamics of the system and the mechanical properties essential to characterize the specimens were extracted from the measured Frequency Response Function (FRF).

The experimental setup whose components are detailed in FIG. 3b consists of a vertical SignalForce Shaker V20 applying dynamic loading to the bottom of the specimen. A load cell (PCB Piezotronics 208C02) is attached to the bottom steel plate of each specimen to measure the vertical forces effectively transmitted from the shaker; gravity loads are applied on the specimens in the form of a solid stainless steel cylinder bolted to the upper steel plate (1 kg and 2 kg at a time). Two accelerometers, a PCB Piezotronics M3531318 at the top and a high sensitivity single-axis accelerometer KISTLER 8640A50 at the bottom, were used to record accelerations (in g) at the top of the added mass (stainless steel cylinder) and at the bottom of the lower steel plate respectively. LABVIEW software was used to acquire and process experimental data.

Initial tests conducted at the Dynamics Laboratory of the University of Exeter (UK) aimed at determining the dynamic properties of the specimens. To measure their resonance frequency specimens were loaded using sine-sweep excitation within a frequency range 0-5000 Hz, with an input amplitude of 0.2 VRMS (Root Mean Square Voltage). To reduce the presence of measurement noise on the FRF estimates, RMS spectral averaging was performed on ten spectral records (computing the square root of the average of the sample values squared) and each spectral record was weighted using linear weighting, which combines spectral records with equal weighting. Vibration tests were also performed on one of the 3 mm steel plates alone to define its natural frequency and ultimately to assess any dynamic interaction with the dynamic behaviour of the rubber-graphene compound. FIG. 3c shows the experimental setup for tests conducted on a square steel plate. An accelerometer is positioned at the top of the plate and a load cell is at the bottom to record the applied force.

### 3. DAMPING, VERTICAL STIFFNESS AND COMPRESSION MODULUS IN THE GRAPHENE-RUBBER COMPOSITE

The natural frequency and damping of the specimens were initially estimated from the FRF using the peak-picking and half-power bandwidth methods. Peak picking is a method operating in the frequency domain where each peak corresponds to one natural mode and it is applicable when the modes of the system are well separated in the frequency domain. Half-power bandwidth is based on the assumption that the damping of a system ζ is proportional to the width of the resonant peak about the peak's centre frequency.^{[19]} The natural frequency of Set 1 and Set 2 samples is estimated experimentally via FRF and the damping ratio ζ of the mass-spring-damper system is calculated using the equation:

2ζ=η (1)

where

η=(f_{b}²−fₐ²)/(2·fₙ²) (2)

and where fₙ is the frequency of resonant peak in Hz; f_{b} is the higher frequency at amplitude H/\sqrt{2}; fₐ is the lower frequency at amplitude H/\sqrt{2}/\sqrt{2}; and H is the amplitude of the response at fₙ.

The damping estimated using Equation (1) was compared with the damping estimated using the least-squares fitting rational function (LSRF) approach.^{[20]} LSRF is an estimation-based method fitting data by rational functions that minimize the maximum error between the fitting function and the data. It provides higher-accuracy results for SISO (single-input-single-output) frequency-domain systems with real-valued state-space parameters, therefore applicable to the observed SDOF mass-spring-damper system. The linearity of the experimental system and the dominance of the first mode were verified on a Nyquist diagram—plotting real versus imaginary data of FRFs.

To define the vertical stiffness KᵥE_{c} Kᵥ of Set 1 and Set 2 samples a rearranged equation of a SDOF system is used:

Kᵥ=4π²fₙ²MKᵥ=4π²fₙ²M (3)

where fₙ is the experimental vertical natural frequency and M is the applied mass. Knowing the vertical stiffness Kᵥ, the instantaneous compression modulus E_{c} of the specimen is calculated from the theory developed by Kelly and Takhirov for fibre-reinforced elastomeric isolators:^{[4]}

E_{c}=Kᵥ·tᵣ/A (4)

where A is the cross sectional area of the bearing and tᵣ is the total thickness of rubber in the device. For the Set 2 circular specimens the cross sectional area is A=πd²/4 where d is the diameter of the circular rubber pad (47 mm); for the Set 1 square specimens the cross sectional area is A=a² where a is the side of the square rubber pad (47 mm).

Values of vertical stiffness and instantaneous compression modulus of the graphene-rubber composite are summarized in Table 1 and 2 and are discussed hereinafter.

### 4. ANALYSIS OF EXPERIMENTAL RESULTS

### 4.1. Results Set 1 Specimens (Square)

FRFs of Set 1 samples were used to evaluate the specimens' mechanical behaviour and to extract dynamic properties such as the natural frequency, and damping. FRFs show that the vertical natural frequency of the two specimens 1.2 and 1.3 made of a rubber pad and a few layer graphene on top (either thin or thick) is higher than the natural frequency of the specimen made of pure rubber (1.1). This result proves that specimens 1.2 and 1.3 are stiffer vertically than specimen 1.1, and that the increase in vertical stiffness is likely due to the added layers of graphene. Layers of graphene act as reinforcements: by restricting the freedom of the rubber to bulge, and by inducing tensile stresses during their action in limiting the bulging therefore enhancing the vertical stiffness of the elastomer. The vertical natural frequency of the three specimens is plotted in FIG. 4, also showing that for exciting frequencies less than 250 Hz (i.e. a frequency ratio less than 0.7) the dynamic response of the specimens is disturbed by the dynamic response of the confining steel plates. Despite this, the disturbance does not compromise the experimental measurements because it occurs at an outer frequency away from the natural frequencies of the three specimens. The resonance frequency estimated experimentally from FRF was compared with the resonance frequency estimated using the LSRF approach described in Section 3 and it was found to be within 1 percentile difference for specimen 1.1 and 2 percentile difference for specimen 1.2 and 1.3. LSRF stabilization diagrams are shown in FIG. 5 and confirm that specimens 1.2 and 1.3 have natural frequencies higher than specimen 1.1. Those results show that the LSRF approach gives reliable results for the SDOF system investigated here. Results are encouraging: seismic elastomeric devices would require very high vertical stiffness compared to the horizontal one and graphene appears to be a viable alternative to replace steel shim in SREI (or fibres in FREI) and to provide the required increase in the vertical stiffness. In addition, the use of graphene in seismic devices will reduce the weight of the devices further, therefore costs.

This paper is devoted to test graphene rubber compounds to be used for prototypes of elastomeric isolators able to isolate structures from vibrations. Isolation of structures from external excitation occurs for the ratio of the output signal (i.e. accelerations recorded at the top of the added mass MM) to the input signal (i.e. accelerations recorded on the lower steel plate) less than 1; it is known as transmissibility T. The Cross-Over Frequency at T=1 for the three Set 1 samples is given in FIG. 4, showing that for a given value of transmissibility less than 1, the specimen 1.3 (with thin layer of graphene) isolates a structure from higher frequencies than specimens 1.1 and 1.2. From FIG. 4 it is also evident that for high-frequency ratios (i.e. exciting frequency to frequency of the mass-spring-damper system) the transmissibility is not strongly dependent on the loss factor (i.e. damping). This confirms that the hysteretic model suggested by Kelly is the most appropriate theoretical model to describe the behaviour of rubber material reinforced with graphene as it predicts a larger degree of dynamic isolation at high-frequency ratio than do other models (e.g. viscous model).^{[1]} Hence, the hysteretic model can be extended to graphene-reinforced compounds although further amendments will be essential, as discussed in Section 4.2.^{[1,4]} Indeed, the unprecedented concept of replacing steel shims with few layer graphene nanosheets to make GREI demands the development of a bespoke theoretical model on which the authors are currently working.

Damping ratio of Set 1 samples, estimated using the method described in Section 3, are summarized in Table 1. Results show that by adding a few layer of graphene on a rubber pad, the damping factor ζ increases from 0.12 (in specimen 1.1) to 0.15 (in specimen 1.3). Comparing this result to high-damping SREI, also known as high-damping steel reinforced rubber bearings (HDRB), for which the characteristic damping factor is between 0.1 (10%) and 0.2 (20%). For instance, results from tests presented in^{[21]} show that in HDRB with filled natural rubber have ζ=0.14 (14%), which is a typical value for seismic elastomeric isolators. This value is very close to the damping of specimen 1.3, proving that in a natural rubber pad reinforced with a thin layer of graphene it is relatively easy to achieve the damping ratio of high damping rubber. Such an increase in damping ratio is likely due to the presence of graphene and it is beneficial to vibration isolation systems made with rubber, as it would enable using low damping natural rubber in lieu of expensive high damping rubber (requiring an additional manufacturing process to be filled with reinforcing particles). Results also show that increasing the quantity of graphene in the graphene-rubber compound does not necessarily correspond to an increase in damping. For instance, specimen 1.2 has more graphene (thick layer) but a lower damping ratio than specimen 1.3. Hence, it is crucial to study the relationship between the quantity of graphene added on rubber and the properties of the graphene-rubber compound.

Experimental data from FRF were plotted on the Nyquist plane and they appear to distribute properly on a circle generated using a circle fit method. Such a distribution corroborates the hypothesis that the analysed system is behaving linearly and has one significant natural frequency. FIG. 6 shows Nyquist planes for the three Set 1 samples with 1 kg vertical load applied.

The instantaneous compression modulus E_{c} of the graphene-rubber compound is calculated from Equation (4). E_{c} increases with the vertical stiffness therefore it is greater in specimens 1.2 and 1.3 than in specimen 1.1. Experimental value of instantaneous compression modulus of Set 1 samples are summarized in Table 1.

It is worth noticing that an increase of concentration of graphene (from thin to thick layer) does not enhance further natural frequency and damping factor. Recent studies found similar results with respect to the evolution of functionalities of graphene composites by varying concentration of graphene.^{[11, 12]} In nanoengineered concrete reinforced with graphene it was observed an increase of strength and of a range of mechanical properties (e.g. compressive strength, flexural strength); yet a further increase of graphene concentration in the reinforced concrete reduces some of them (e.g. plastic strain). This demanded a systematic study on the graphene reinforced concrete to investigate the evolution of its functionalities. Research studies also demonstrated that strength in graphene-elastomer nanocomposite is sensitive to preparation techniques, many of which can be employed only for the incorporation of small amounts of graphene, since the use of higher amounts can easily lead to an increase in the cross-link density of the elastomer, which will diminish the effect of the functionalization. It follows that the preparation of Set 2 specimens and their peculiar geometry (alternated layers of rubber and graphene) may have produced microstructural changes weakening the specimens and affecting their mechanical properties.

TABLE 1
Mechanical properties of three specimens made with a
rubber pad (specimen 1.1); a rubber pad with a thick
layer of graphene on top (specimen 1.2); a rubber pad
with a thin layer of graphene on top (specimen 1.3).

| | | Rubber Pad + | Rubber Pad + |
|---|---|---|---|
| | | Graphene | Graphene |
| | Rubber Pad | Thick layer | Thin layer |
| | (specimen | (specimen | (specimen |
| | 1.1) | 1.2) | 1.3) |
| Natural Frequency | 315 | 338 | 340 |
| fₙ [Hz] | | | |
| Cross-Over Frequency | 452 | 493 | 501 |
| [Hz] | | | |
| Damping factor ζ | 0.1236 | 0.1245 | 0.1455 |
| (Peak picking) | | | |
| Vertical Stiffness | 3942157 | 4510172 | 4590590 |
| [N/m] (SDOF) | | | |
| Increase Vertical | — | 14.41 | 16.45 |
| Stiffness [%] | | | |
| Instantaneous | 3.41E+07 | 3.90E+07 | 3.97E+07 |
| Compression | | | |
| Modulus E_{c} [N/m²] | | | |

LSRF method

| | | | |
|---|---|---|---|
| Natural Frequency | 318 | 344 | 348 |
| fₙ [Hz] | | | |
| Damping factor ζ | 0.1212 | 0.1233 | 0.1292 |

### 4.2. Results on Set 2 Specimens (Circular)

In this section experimental results from dynamic tests conducted on two circular specimens (specimen 2.1 and specimen 2.2) with 1 kg and 2 kg vertical load applied one at a time are presented and discussed. The vertical natural frequency of the two specimens was found using the experimentally measured FRF. The natural frequency in the specimen made of nine rubber pads (specimen 2.1) was found to be higher than the frequency of the specimen made of rubber pads alternated with eight layers of graphene (specimen 2.2). This may indicate that eight layers of graphene are added at the expenses of the vertical stiffness of the layered specimen. Vertical natural frequency of Set 2 samples are depicted in FIG. 7, also showing the transmissibility. As the natural frequency is lower in specimen 2.2 than in specimen 2.1, the vertical stiffness calculated experimentally from the mass-spring-damper SDOF system is also lower in the graphene-reinforced rubber specimen compared to that in the specimen made of rubber pads only. Besides that, experimental results indicate a lower damping factor (calculated using the pick peaking method discussed in Section 3) of the specimen reinforced with graphene compared to the damping factor of the specimen made of rubber pads only. Such a decrease of vertical frequency, vertical stiffness and damping factor in the specimen reinforced with graphene is likely due to an excessive quantity of graphene present in the specimen 2.2, provoking loss of adhesion between layers of graphene-reinforced rubber and unexpected inner behaviour between the graphene particles.

Results on tests conducted on Set 2 samples reaffirm those on Set 1 samples and in particular on specimens 1.2 and 1.3. Indeed, the mechanical properties of specimen 1.2 (with a thick layer of graphene), e.g. natural frequency, damping, vertical stiffness, instantaneous compression modulus, are inferior to the properties of the specimen 1.3 (with thin layer of graphene) indicating that high concentration of graphene weakens the specimen. A comprehensive overview of the experimental results for Set 2 samples is presented in Table 2.

To design a base isolated system it is essential to know the instantaneous compression modulus E_{c} of the elastomeric isolators. Here E_{c}E_{c} is calculated using the theory developed in^{[4]}, then it is compared with the compression modulus EₑₓEₑₓ extracted from the experimental hysteresis loop, defined as the ratio between the tensile stress (σ) and the vertical deformation (ε), such as

Eₑₓ=σ/ε (5)

The tensile stress σ is calculated as:

σ=F/A (6)

where FF is the force applied on the sample by the vertical shaker and recorded at the bottom of the lower steel plate and A is the cross sectional area of the sample. The vertical deformation ε is calculated as:

ε=Δλ/λ (7)

where Δλ is the relative displacement such as the difference between the displacement recorded at the bottom of the lower steel plate and the displacement recorded at the top of the specimen; λ is the high of Set 2 samples (h=13.5 mm). Accelerations recorded by two accelerometers were integrated to extract the vertical displacements of the specimens, and a filter was applied to remove baseline errors accumulated in the numerical integration.

The experimental Young's Modulus EₑₓEₑₓ is about 10 times greater than the instantaneous compression modulus E_{c}E_{c} calculated using the theory developed for FREI.^{[4]} This result shows that the models discussed in^{[4]} are not a comprehensive representation of the mechanical behaviour of GREI; additional experimental tests are essential to develop a theory to better described the dynamic behaviour of GREI. Despite inconsistency between E_{c} and EₑₓEₑₓ, specimen 2.2 with either 1 kg or 2 kg applied load has lower E_{c} than the specimen made of rubber pads only (2.1). This confirms that an excessive quantity of graphene in the specimen (i.e. eight layers of graphene in specimen 2.2) is likely to worsen its mechanical properties and that although there is evidence that graphene enhances the properties of rubber, it is essential encountering the optimal quantity.^{[12]} In addition, specimens were handmade and it was observed that the epoxy that was used to bind the layers of rubber was too dense and it creates micro cavities that prevents the rubber pads to adhere uniformly to one another. Both Set 2 samples were excited at their natural frequency and σ−εσ−ε plots are shown in FIG. 8.

To compare the hysteresis loops and evaluate the energy losses in load-unload cycles, specimens 2.1 and 2.2 were excited at their natural frequency and equal amplitude. The relative vertical displacement corresponding to the difference between the displacement at the bottom and the displacement at the top of the specimen is estimated experimentally, and it is plotted versus the forces effectively transmitted from the shaker in FIG. 9.

Overall specimen 2.1 loses much more energy (as a consequence of its higher damping) than specimen 2.2. For instance, the energy loss in load-unload cycles of specimen 2.2 (FIG. 9d) is about 8.5% less than the energy loss in load-unload cycles of specimen 2.1 (FIG. 9c). This again confirms that, despite graphene layers enhance the properties of the rubber pads (specimen 1.2 and 1.3), an excessive quantity of graphene, which in this case is due to the presence of eight layers of graphene, may be counterproductive for an isolation system. Hence, it is essential to determine the optimal quantity of graphene to be transferred on rubber pads to design an efficient isolation system.

TABLE 2
Mechanical properties of Set 2 samples.

| | | Round | | Round |
|---|---|---|---|---|
| | Round | Graphene- | Round | Graphene- |
| | Rubber | Rubber | Rubber | Rubber |
| | Layers | Layers | Layers | Layers |
| | with 1 kg | with 1 kg | with 2 kg | with 2 kg |
| | (specimen | (specimen | (specimen | (specimen |
| | 2.1) | 2.2) | 2.1) | 2.2) |
| Resonance Frequency | 506 | 271 | 345 | 205 |
| [Hz] | | | | |
| Damping factor ζ | 0.273 | 0.183 | 0.293 | 0.2013 |
| (Peak picking) | | | | |
| Energy loss in the | 1.00% | 4.89% | 1.00% | 4.27% |
| hysteresis loop | | | | |
| Experimental Young's | 1.00E+09 | 2.60E+08 | 8.50E+08 | 2.71E+08 |
| Modulus Eₑₓ [N/m²] | | | | |
| Instantaneous | 7.87E+07 | 2.26E+07 | 7.31E+07 | 2.58E+07 |
| Compression | | | | |
| Modulus E_{c} [N/m²] | | | | |
| Vertical Stiffness | 1.01E+07 | 2.90E+06 | 9.40E+06 | 3.32E+06 |
| [N/m] (SDOF) | | | | |

### 5. SUMMARY AND CONCLUSIONS

Typically seismic elastomeric isolators are made with high damping rubber to reduce further horizontal accelerations induced in structures during an earthquake, and are reinforced with steel plates that provide large vertical stiffness. Experimental results conducted on the three Set 1 samples with 1 kg vertical load applied showed that when adding a few layer graphene on the top of a 15 mm thick rubber pad the vertical stiffness of the specimen increases. In particular, the vertical stiffness increases by 16.5% when a thin layer of graphene is added on the top of the rubber pad and by 14.4% when a thick layer of graphene is added.

Experimental results also show an increase of 17.7% in the damping of the composite rubber-thin layer of graphene (specimen 1.3) and of 0.7% in the composite rubber-thick layer of graphene (specimen 1.2). Thick and thin layers of graphene are produced by varying the quantity of graphene solution in water solvent. Results also show that a few layer graphene transferred on top of the specimen enhance the damping; hence natural rubber can be used in lieu of high damping rubber, saving the cost of reinforcing rubber with particulate fillers. Adding a few layer graphene is proved to be a viable and low cost alternative to reinforce elastomeric isolators and to replace heavy steel reinforcing shims.

The rubber pad with a thick layer of graphene on top is shown to be less performant than the rubber pad with a thin layer graphene. This is likely due to an excessive quantity of graphene concentration used to make the graphene layer thick, causing unexpected behaviour of the graphene particles and loss of chemical bounds.

Unwanted behaviour of the rubber pad due to high concentration of graphene is evident from the experimental results on Set 2 samples. The specimen made with nine rubber pads alternated with eight layers of graphene exhibits lower vertical stiffness and damping factor than the specimen made of nine rubber pads only. Eight layers of graphene worsen the performance of the rubber, although it is likely that less layers would enhance its mechanical properties, as it has seen in the response of specimen 1.3 with a thin layer of graphene on top. An increment of vertical stiffness was expected in specimen 2.2 (GREI) with respect to specimen 2.1, similar to the increment that was observed in specimen 1.3 with respect to specimen 1.1. This would be achieved by transferring the optimal quantity of graphene on the rubber pads. Using the theory developed by Kelly wand assuming a compression modulus G=0.4 MPa which is a typical value in SREI, it is possible to design a SREI with the same vertical stiffness as GREI. It would have 15 layers of steel shims interposed between 16 layers of 1.5 mm rubber.^{[1]} Hence, a SREI would be heavier and taller than GREI, proving that a GREI with optimal concentration of graphene would match the mechanical properties of a typical SREI, as well as being lighter therefore easier to transport and install. The quest for future research is to determine the optimal quantity of graphene to be transferred homogenously on the rubber pad that would enhance its mechanical properties.

It is worth mentioning that Set 1 and Set 2 samples were handmade and the epoxide used to bind layers of rubber (and layers of reinforced rubber) was dense and could have not adhered homogenously on the surface, causing an amount of scatter and microstructural changes weakening the specimens and their mechanical properties.

These results lay the foundation for expanding this research into a new generation of building-protection devices known as seismic metamaterials.^{[22,23]} For instance, GREI could be integrated with composite foundations that employ the physics of seismic metamaterials to create on-site filters that reduced the energy transferred from a seismic wave to the building. Also, they could be employed in the realization of periodic foundations which use periodic materials (e.g. phononic crystal) to change the pattern of the earthquake' energy and reduce the response of the upper structure from excitations within the frequency band of interest.

### REFERENCES

[1] J. M. Kelly, Earthquake-Resistant Design with Rubber, Springer 1997.
[2] A. Strauss, Eng. Struct. 2014, 75, 402.
[3] L. Scott, Engineering News Record. 17 Jul. 2017, accessed: October, 2018.
[4] J. M. Kelly, S. M. Takhirov, PEER 11, 2002, University of California, Berkeley, CA.
[5] P. M. Osgooei, M. J. Tait, D. Konstantinidis, Eng. Struct. 2017, 137, 245.
[6] J. M. Kelly, D. Konstantinidis, Mechanics of rubber bearings for seismic and vibration isolation, Chichester, UK: John Wiley & Sons, 2011.
[7] P. M. Osgooei, N. C. Van Engelen, D. Konstantinidis, M. J. Tait, Eng. Struct. 2015, 85, 293.
[8] M. R. Marsico, J. M. Kelly, Eng. Struct. 2013, 56, 656.
[9] P. Angeli, G. Russo, A. Paschini, Int. J. Solids Struct. 2013, 50, 3519.
[10] A. E. Javid, J. Kelly; J. L. Sackman, United States Patent, 1999, U.S. Pat. No. 5,904,010A.
[11] D. Dimov, I. Amit, O. Gorrie, M. D. Barnes, N. J. Townsend, A. I. S. Neves, F. Withers, S. Russo, M. F. Craciun. Adv. Funct. Mater. 2018, 28, 1705183.
[12] D. G. Papageorgiou, I. A. Kinloch, R. J. Young, Carbon, 2015, 95, 460.
[13] J. D. Wang, Y. F. Zhu, X. W. Zhou, G. Sui, J. Liang, Appl. Polym. Sci. 2006, 100, 4697.
[14] R. K. Prud'Homme, B. Ozbas, I. Aksay, R. Register, D. Adamson, United States Patent, 2010, U.S. Pat. No. 7,745,52882.
[15] J. Wu, W. Xing, G. Huang, H. Li, M. Tang, S. Wu, Y. Liu, Polymer. 2013, 54, 3314.
[16] D. W. Shin, M. D. Barnes, K. Walsh, D. Dimov, P. Tian, A. I. S. Neves, C. D. Wright, S. M. Yu, J. B. Yoo, S. Russo, M. F. Craciun, Adv. Mater. 2018, 30, 1802953.
[17] K. R. Paton, E. Varrla, C. Backes, R. J. Smith, U. Khan, A. O'Neill, C. Boland, M. Lotya, O. M. Istrate, P. King, T. Higgins, S. Barwich, P. May, P. Puczkarski, I. Ahmed, M. Moebius, H. Pettersson, E. Long, J. Coelho, S. E. O'Brien, E. K. McGuire, B. Mendoza Sanchez, G. S. Duesberg, N. McEvoy, T. J. Pennycook, C. Downing, A. Crossley, V. Nicolosi, J. N. Coleman, Nat. Mater. 2014, 13, 624.
[18] A. De Sanctis, J. D. Mehew, S. Alkhalifa, C. P. Tate, A. White, A. R. Woodgate, M. F. Craciun, S. Russo, Rev. Sci. Instrum. 2017, 88, 055102
[19] D. J. Ewins, Modal Testing: Theory and Practice, Wiley, 1984.
[20] A. A. Ozdemir, S. Gumossoy, in Proc. 20th World Congress International Federation of Automatic Control, Toulouse, France, 2017.
[21] T. Nersessyan, G. Hovhannisyan, A. Tonoyan, K. Avanesova, J Structural Control, 2001, 8, 219.
[22] Y. Yan, A. Laskar, Z. Cheng, F. Menq, Y. Tang, Y. L. Mo, Z. Shi, J. Appl. Phys. 2014, 116, 044908.
[23] 0. Casablanca, G. Ventura, F. Garescì, B. Azzerboni, B. Chiaia, M. Chiappini, G. Finocchio, J. Appl. Phys. 2018, 123, 174903.

1. An elastomeric isolator comprising a layer of an elastomeric material, wherein the layer of elastomeric material is provided with a reinforcing material layer in the form of a graphene layer.

2. An isolator according to claim 1, wherein the elastomeric material is a natural or synthetic rubber.

3. An isolator according to claim 1, wherein the graphene layer is applied to a face of the elastomeric material.

4. An isolator according to claim 1, wherein the graphene layer comprises at least one few layer graphene nanosheet.

5. An isolator according to claim 1, wherein the elastomeric material is located between a pair of steel plates.
